(19) United States
(12) Patent Application Publication
(10) Pub. No.: US 2011/0202625 A1
(43) Pub. Date: Aug. 18, 2011

(54) Storage device, system and method for data share

(75) Inventors: Hong-Chi Yu, Kaohsiung City (TW); Mao-Ting Chang, Kaohsiung City (TW)

(73) Assignee: WALTON ADVANCED ENGINEERING INC., Kaohsiung (TW)

(21) Appl. No.: 13/064,840

(22) Filed: Apr. 20, 2011

(30) Foreign Application Priority Data
Feb. 18, 2010 (TW) 100105474

(51) Int. Cl. G06F 15/167

(52) U.S. Cl. 709/213

(57) ABSTRACT

The present invention is one storage device for data share which comprises a device body with a USB communications interface unit, a memory unit, and a control unit wherein the memory unit has an executive file/program comprising a group management module used to manage a group/peer list and the group list has at least a group ID and a peer ID. Accordingly, the storage devices with the same group ID can be referred to as “peers” inside the group and mutually share files saved in respective storage devices when at least two storage devices with the same group ID are separately plugged onto computers and complete login on the central server via Internets.

### BACKGROUND OF THE INVENTION

1) Field of the Invention

The present invention relates to a storage device, a system and a method, especially to a storage device, a system and a method for data share.

2) Description of the Prior Art

Arrival of the Internet era prompts not only information share accelerated but also information technologies popularized and evolving. For instance, more and more 3C products of computers, communications, and consumer electronics have been extensively introduced into consumers' lives.

In this regard, the portable data storage device based on a combination of the Universal Serial Bus (USB) transmission interface and the non-volatile memory (e.g., flash memory) is popular with the general public and substantially available recently due to its advantages such as lightness, portability, and plug-and-play.

For a portable data storage device, a used who intends to copy data of Computer A into Computer B should plug the storage device onto a transmission interface of Computer A prior to data of Computer A saved in the storage device and then connect the storage device onto a transmission interface of Computer B for stored data copied or moved to Computer B for data of Computer A shared by Computer B.

However, there are still some problems existing in the method for files transmitted between a portable data storage device and a computer: (1) Data not immediately and efficiently shared due to an actual distance between computers; (2) Transmission efficiency simply reduced by 50% during a procedure of the same data transmitted twice in a way of a two-stage “copy in and copy out”.

Furthermore, the Peer to Peer (P2P) network is one decentralized technology-based network which technically depends on calculation abilities and bandwidths of participants (peers) in networks rather than a few servers used to transmit data. In a P2P network, there is one important feature of resources such as storage space and calculation ability provided by all peers (for transmission and reception) so that the capability of a whole system is expanded with more and more peers joining and corresponding requests increased. Among multiple applications of this type of network, a P2P network used to provide documents or other contents (such as audio, video or data with various formats) for share has been extensively applied.

However, there still have been some problems existing in a powerful P2P network: (1) Inconvenience: Data/file is not transmitted by one consumer who is away from one immobile personal computer with utilities for data/file share under the current P2P technology; (2) Unreliability and unsafety: Validity of each shared data is not effectively verified in the network under assistance of servers for directories established due to no central control system existing in a P2P network for data share.

### SUMMARY OF THE INVENTION

In order to solve the said problems, the present invention provides a storage device for data share comprising a device body with a USB communications interface unit, a memory unit and a control unit wherein the memory unit has an executive file/program comprising a group management module used to manage a group/peer list with at least a group identification (ID) and peer ID. Accordingly, at least two storage devices (with the same group ID) separately plugged onto computers and completing login on a central server via Internets will be referred to as “peers” of the group and share files saved in two storage devices by means of the same group ID.

Additionally, the present invention providing a storage device system for data share comprises at least a remote server and the storage device wherein the remote server comprises at least a storage space used to save digital data transmitted by a peer and allow the peer to directly download data from/upload data to the server.

Therefore, the principal object of the present invention is to deliver files shared by peers with the same group ID and make sure of reliability and safety of received data under the structure of a group/peer list.

The other object of the present invention is to deliver data transmitted and received between any electronic products by peers having connected to Internets and to effectively share data without restrictions of some factors such as realistic distance and specific electronic product.

The further object of the present invention is to make a remote server provided with at least a storage space in which a peer downloads data from or uploads data to a server directly rather than via another peer for data conveniently and efficiently transmitted.

To this end, the present invention has the principal technical measures delivered with the following techniques.

The present invention as a storage device for data share has a device body comprising a USB communications interface unit, a memory unit and a control unit wherein the USB communications interface unit is used to electrically connected to a port on a computer; the memory unit providing readable/writable digital data comprises an executive file/program with a group management module used to manage a group/peer list in which there is at least a group ID and a peer ID; the control unit electrically connected between the memory unit and the communications interface unit is used to issue a request for controlling data input and output and comprises a virtual device module; the device body is characteristic of being developed to a peer which share digital data with other peers recorded in the group/peer list via Internets when the USB communications interface unit electrically contacts with the port of the computer, the virtual device module of the control unit issues a request for connecting a virtual device, and the computer automatically executes the executive file/program.

The purposes and the technical issues with respect to the present invention are further embodied with the following technical measures.

In the said storage device for data share, the executive file/program comprises a communications module which is used to transmit a message to or receive a message from at least a remote server (or at least a peer) via Internets.

In the said storage device for data share, the executive file/program comprises a file share module which has a file list used to manage addition, deletion, and share of digital data.

In the said storage device for data share, the executive file/program comprises a transmission/reception module which is used to transmit a message to or to receive a message from at least a remote server (or at least a peer) via Internets.

In the said storage device for data share, there is at least one module among the communications module, the group management module, the file share module and the transmission/reception module or a combination of any modules hereinbefore exported to a display device of the computer via a user interface.

The present invention as one storage device system for data share comprises at least a remote server as well as one type of storage device for data share and features: the device body plugged into the computer's port and connected to the remote server via Internets is developed to be one peer; the remote server is used to receive and integrate the peer's group/peer list as well as file list and transmit the file list to other peers specified in the group/peer list.

The purposes and the technical issues with respect to the present invention are further embodied with the following technical measures.

In the said storage device system for data share, the remote server comprises at least a storage space used to save digital data which is transmitted from the peers.

In the said storage device system for data share, the remote server comprises a file list which is used to record digital data transmitted to the storage space by the peers, delivered to the peers, and exported to a display device of the computer via a user interface.

The present invention is one method of operating a storage device for data share by steps shown as follows: (1) A device body's USB communications interface unit is electrically connected to a computer's port; (2) A request for connecting a virtual device is issued to the computer by a control unit's virtual device module and the executive file/program (13) is automatically executed by the computer; (3) The device body is developed to be a peer with the communications module transmitting a group ID (or a peer ID) via Internets and connected to at least a remote server; (4) A file list is transmitted to the remote server by the file share module via Internets; (5) A peer's file list is browsed by another peer with the same group ID through a user interface which has been exported to a computer's display device and a request to download digital data saved in the file list is issued to the peer by a communications module; (6) The digital data is uploaded to another peer via one peer's transmission/reception module and downloaded by another peer's transmission/reception module with the request received by one peer's communications module.

In contrast to prior arts, the present invention is effective in: (1) Files shared by peers with the same group ID and reliable and safe data received assuredly under the structure of a group/peer list; (2) Data effectively transmitted and received by peers which are distributed among any electronic products via Internets for data shared without restrictions of multiple factors such as realistic distance and specific electronic product; (3) Data uploaded to/downloaded from a server with at least a storage space by a peer directly rather than through another peer for data conveniently and effectively transmitted.

### BRIEF DESCRIPTIONS OF THE DRAWINGS

FIG. 1 is the sectional view of the structure of the present invention.

FIG. 2 is the block diagram of the present invention.

FIG. 3 is the schematic diagram to operate the present invention.

### DETAILED DESCRIPTIONS OF THE PREFERRED EMBODIMENTS

For objects, characteristics, and effects obviously and easily understood, the preferred embodiments of the present invention are particularly interpreted as follows:

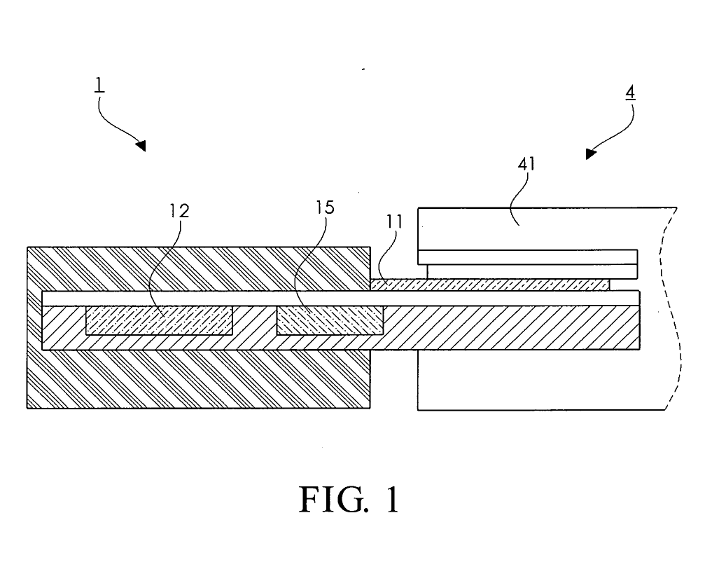

FIGS. 1, 2 and 3 indicate the principal embodiments of the present invention, a storage device for data share, which comprises a device body (1) with a USB communications interface unit (11), a memory unit (12) and a control unit (15).

The USB communications interface unit (11) is used to electrically connect to a port (41) of a computer (4); the memory unit (12) is used to provide readable/writable digital data; the control unit (15) electrically connected between the memory unit (12) and the communications interface unit (11) is used to issue a request for controlling data input as well as output and transmit commands between electronic products.

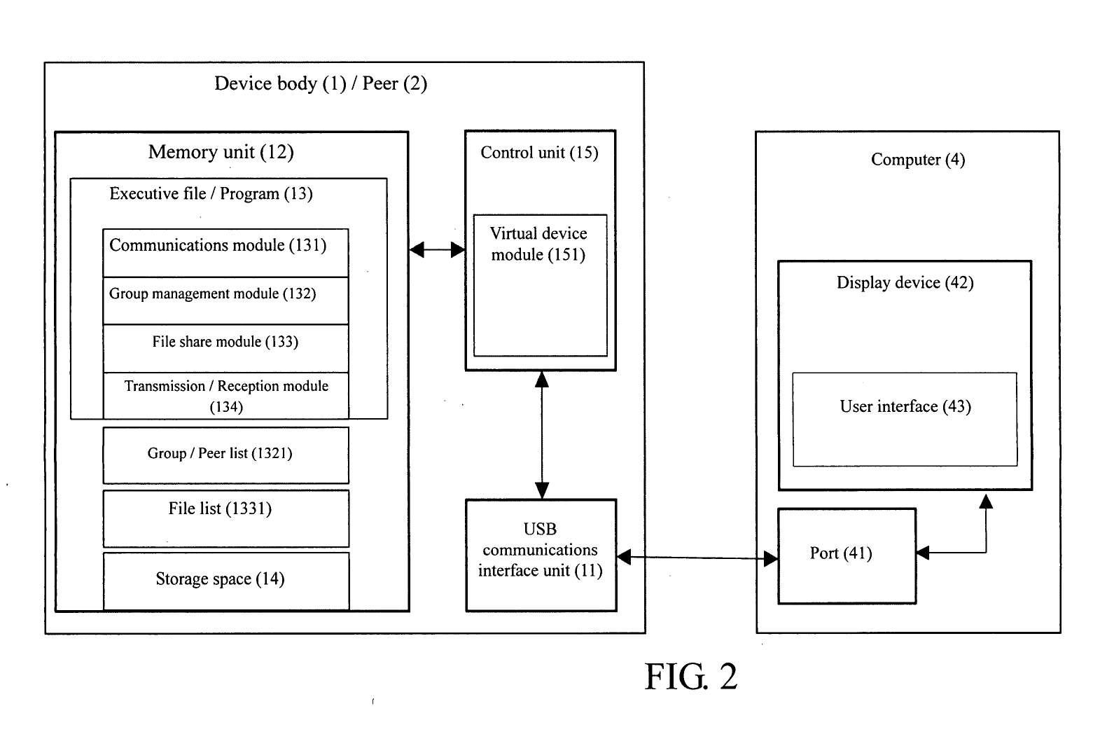

Referring to FIG. 2 first which indicates the memory unit (12) comprising an executive file/program (13) and a storage space (14). In this regard, the storage space (14) allows a user to save at least one digital data shared by other users (i.e., digital data saved in the storage space (14) is purposely predetermined to be data for share) and is unquestionably planned to a private zone in which there is no digital data referred to as data shared by other peers; the executive file/program (13) comprises a group management module (132) which is used to manage a group/peer list (1321) with at least a group ID and a peer ID.

The control unit (15) comprises a virtual device module (151). Preferably, the virtual device module (151) could include but be not limited to any virtual device such as CD-ROM, floppy disk or floppy.

Referring to FIGS. 1 and 2 which indicate a request for connecting a virtual device issued by the virtual device module (151) of the control unit (15), the executive file/program (13) automatically executed by the computer (4), and the device body (1) via Internets developed to be a peer (2) which uses a group ID (or a peer ID) recorded in the group/peer list (1321) to share digital data with another peer (2′) connected to Internets and possessing the same group ID when the USB communications interface unit (11) electrically contacts with the port (41) of the computer (4).

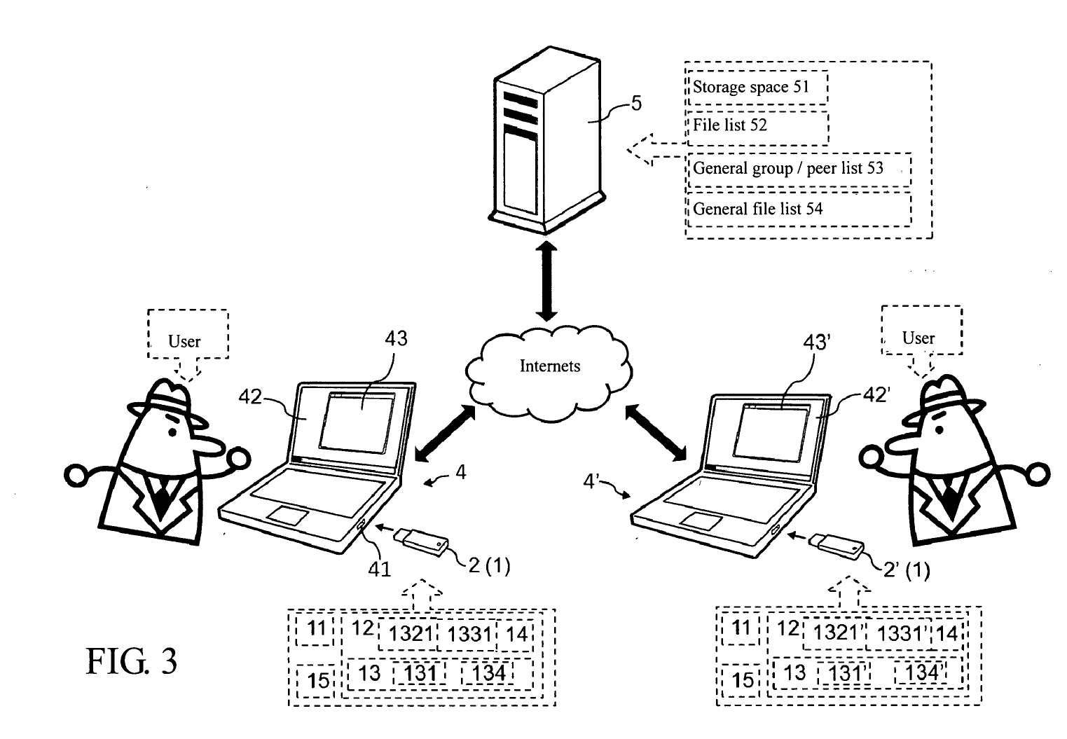

Specifically, referring to FIGS. 2 and 3 which indicate the executive file/program (13) comprising a communications module (131), a file share module (133) and a transmission/reception module (134). In this regard, the communications module (131) is used to transmit messages to or receive messages from at least a remote server (5) or at least a peer (2′) via Internets; the file share module (133) has a file list (1331) which is used to manage addition, deletion and share of digital data and specifically comprises multiple types of information such as file name, size, file identifier, or time for a file developed; the transmission/reception module (134) is used to transmit data to or receive data from at least a remote server (5) or at least a peer (2′) via Internets.

Preferably, there is at least one module among the communications module (131), the group management module (132), the file share module (133) and the transmission/reception module (134) or a combination of any modules hereinbefore exported to a display device (42) of the computer (4) by means of a user interface (43) and the modules hereinbefore are effective in messages added, deleted, modified, or transmitted/received or digital data transmitted/received which includes but is not limited to messages transmitted to or received from the remote server or another peer (2′) by the communications module (131) via the user interface (43); the group management module (132) allows a user to add, delete or modify the group ID and the peer ID recorded in a group/peer list (1321) via the user interface (43); the file share module (133) allows a user to add, delete or modify digital data to be shared via the user interface (43); the transmission/reception module (134) allows a user to transmit digital data to and receive digital data from a remote server or another peer (2′) via the user interface (43).

In practice, the present invention is not limited to multiple types of P2P-based topology structures. The present invention argues digital data is shared in the P2P technology structure based on the group/peer list (1321).

Preferably, the present invention also comprising at least a remote server (5) is developed to be a storage device system for data share and deliver the device body (1), which has been plugged into a port (41) of the computer (4) and connected to the remote server (5) via Internets, to become a peer (2); the remote server (5) has a general group/peer list (53) and a general file list (54) which are used to receive and integrate at least a group/peer list (1321 or 1321′) and a file list (1331 or 1331′) of a peer (2 or 2′); the peers (2, 2′) with the same group ID are allowed to transmit/receive the file list (1331′ or 1331).

Preferably, the remote server (5) comprises at least a storage space (51) which is used to save digital data transmitted by the peers (2, 2′). Accordingly, digital data uploaded to the remote server (5) by a peer (2) connected to or disconnected from Internets could be downloaded from the server by another peer (2′) directly rather than through the peer (2). Preferably, the remote server (5) comprises a file list (52) used to record digital data, which is transmitted to the storage space (51) by the peers (2, 2′), transmitted to the peers (2, 2′) and exported to a display device (42) of the computer (4) via a user interface (43) for digital data in the storage space (51) of the remote server (5) downloaded by the peers (2, 2′) with the same group ID.

In the embodiment shown in FIGS. 1, 2 and 3, the operation steps are: (a) The USB communications interface unit (11) of the device body (1) is electrically connected to the port (41) of the computer (4); (b) A request for connecting a virtual device is issued to the computer (4) by the virtual device module (151) of the control unit (15) and the executive file/program (13) is automatically executed by the computer (4); (c) A group ID or a peer ID is transmitted by the communications module (131) via Internets and the device body (1) connecting at least a remote server (5) is developed to a peer (2); (d) A file list (1331) is transmitted to the remote server (5) by the file share module (133) through Internets; (e) The file list (1331) of the peer (2) is browsed by another peer (2′) holding the same group ID as the peer (2) and completing login on a remote server through a user interface (43′) which has been exported to a display device (42′) of a computer (4′) and a request to download digital data in the file list (1331) is issued to the peer (2) by the communications module (131′); (f) Digital data is uploaded to another peer (2′) via the transmission/reception module (134) of the peer (2) with the request received by the communications module (131) of the peer (2) and downloaded by the transmission/reception module (134′) of another peer (2′).

It can be seen that the present invention based on the P2P technology and the structure of a group/peer list delivers digital data uploaded to or downloaded from a remote server (or another peer) by each peer; additionally, the operations for multiple data simultaneously uploaded or downloaded are also performed by any peer.

With the said descriptions, the present invention based on the P2P technology and the structure of a group/peer list is effective in: (1) Reliable and safe data received assuredly; (2) Data effectively transmitted, received, and shared by all peers in any electronic products connected to Internets without restrictions of some factors such as realistic distance and specific electronic product; (3) Data downloaded from/uploaded to a server with at least a storage space by a peer directly rather than through another peer for data conveniently and effectively transmitted.

Despite different communications procedures and required information between each peer and the central server in virtue of multiple types of topology in the P2P technology, the prevent invention should not be restricted to any type of topology in the P2P technology. Any change equivalent to applications of descriptions, claims, or drawings under the structure of a group/peer list shall be rationally covered in claims for the present invention.

Accordingly, the present invention that is different from general conventional storage devices but referred to as creative work among similar products meets patentability and is applied for the patent.

It must be stressed that the said descriptions are only the preferred embodiments of the present invention and any equivalent change in descriptions, claims, or drawings of the present invention is under protection of the technical scope of the present invention which accordingly depends on claims specified hereinafter.

What is claimed is:

1. A storage device for data share comprising:
A device body (1) which comprises:
A USB communications interface unit (11) used to be electrically connected to a port (41) of a computer (4);
A memory unit (12) providing digital data readable/writable and having an executive file/program (13) which comprises a group management module (132) used to manage a group/peer list (1321) with at least a group ID and a peer ID;
A control unit (15) electrically connected between the memory unit (12) and the communications interface unit (11), used to issue a request for controlling data input and output, and comprising a virtual device module (151);
Features shown as follows: The device body (1) via Internets can be developed to a peer (2) which shares digital data with another peer (2′) recorded in the group/peer list (1321) when the USB communications interface unit (11) electrically contacts with the port (41) of the computer (4), the virtual device module (151) of the control unit (15) issues a request for connecting a virtual device, and the computer (4) automatically executes the executive file/program (13).

2. The storage device for data share according to claim 1 wherein the executive file/program (13) comprises a communications module (131) used to transmit messages to or receive messages from at least a remote server (5) or at least a peer (2′) via Internets.

3. The storage device for data share according to claim 1 wherein the executive file/program (13) comprises a file share module (133) with a file list (1331) used to manage addition, deletion, and share of digital data.

4. The storage device for data share according to claim 1 wherein the executive file/program (13) comprises a transmission/reception module (134) used to transmit digital data to or receive digital data from at least a remote server (5) or at least a peer (2′) via Internets.

5. The storage device for data share according to claim 1 wherein the group management module (132) exported to a display device (42) of the computer (4) by means of a user interface (43).

6. The storage device for data share according to claim 2 wherein the communications module (131) exported to a display device (42) of the computer (4) by means of a user interface (43).

7. The storage device for data share according to claims 3 wherein the file share module (133) exported to a display device (42) of the computer (4) by means of a user interface (43).

8. The storage device for data share according to claim 4 wherein the transmission/reception module (134) exported to a display device (42) of the computer (4) by means of a user interface (43).

9. A storage device system for data share comprising:
At least a remote server (5) and the storage device for data share according to claim 1;
Features shown as follows:
The device body (1) is developed to a peer (2) with the device body (1) plugged into the port (41) of the computer (4) and connected to the remote server (5) via Internets; the remote server (5) with a general group/peer list (53) and a general file list (54) is used to receive and integrate at least a group/peer list (1321 or 1321′) as well as a file list (1331 or 1331′) of at least a peer (2 or 2′); peers (2, 2′) with the same group ID can mutually transmit/receive file lists (1331′, 1331).

10. The storage device system for data share according to claim 9 wherein the remote server (5) comprises at least a storage space (51) which is used to store digital data transmitted from the peers (2, 2′).

11. The storage device system for data share according to claim 10 wherein the remote server (5) comprises a file list (52) which is used to record digital data transmitted to the storage space (51) by the peers (2, 2′), is transmitted to the peers (2, 2′), and is exported to a display device (42) of the computer (4) via a user interface (43).

12. A method to operate the storage device for data share with steps shown as follows:
A USB communications interface unit (11) of a device body (1) is electrically connected to a port (41) of a computer (4);
A request for connecting a virtual device is issued to the computer (4) by a virtual device module (151) of a control unit (15) and an executive file/program (13) is automatically executed by the computer (4);
The device body (1) is developed to a peer (2) with a communications module (131) transmitting a group ID or a peer ID via Internets and connected to at least a remote server (5);
A file list (1331) is transmitted to the remote server (5) by a file share module (133) via Internets;
The file list (1331) of the peer (2) is browsed by another peer (2′) holding the same group ID as the peer (2) through a user interface (43′) which has been exported to a display device (42′) of a computer (4′) and a request to download digital data in the file list (1331) is issued to the peer (2) by a communications module (131′);
The digital data is uploaded to another peer (2′) by a transmission/reception module (134) of the peer (2) with the request received by the communications module (131) of the peer (2) and downloaded by a transmission/reception module (134′) of another peer (2′).
